(19) United States
(12) Patent Application Publication
(10) Pub. No.: US 2016/0051112 A1
(43) Pub. Date: Feb. 25, 2016

(54) FLEXIBLE FLAT SUBSTRATES HAVING AN ABRASIVE SURFACE

(71) Applicant: BASF SE, Ludwigshafen (DE)

(72) Inventors: MATTHIAS SCHADE, Ludwigshafen (DE); Rebekka VON BENTEN, Ludwigshafen (DE); Günter SCHERR, Ludwigshafen (DE)

(21) Appl. No.: 14/780,291

(22) PCT Filed: Mar. 18, 2014
(86) PCT No.: PCT/EP2014/055388

§ 371 Date: Sep. 25, 2015

(30) Foreign Application Priority Data
Mar. 28, 2013 (EP) 13161529.6

(51) Int. Cl. A47L 13/16; B05D 1/28; B05D 3/00; A47L 13/17

(52) U.S. Cl. CPC A47L 13/16; A47L 13/17; B05D 1/28; B05D 3/007

(57) ABSTRACT

The invention relates to flexible, flat substrates with a flexible, abrasive surface which comprise 0.1 to 90% by weight of a mixture, based on the uncoated substrate, which comprise the condensation product of 99.985 to 20% by weight of at least one precondensate of a heat-curable resin, 0.005 to 10% by weight of a polymeric thickener selected from the group consisting of biopolymers, associative thickeners and/or completely synthetic thickeners, 0.01 to 10% by weight of a curing agent, 0 to 10% by weight of surface-active substances or surfactants, 0 to 15% by weight of active ingredients and effect substances and 0 to 75% by weight of water, where the mixture comprises 10 to 70% by weight of one or more binders, from the group of polyacrylates, polymethacrylates, polyacrylonitriles, copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins, or mixtures thereof.

The invention relates to flexible, flat substrates with a flexible, abrasive surface and to their use as cloths for the cleaning of surfaces in the home and in industry.

WO-A-2010/010046 discloses flexible, flat substrates with an abrasive surface obtainable by applying an aqueous solution or dispersion of a heat-curable resin. The flexible, flat substrates used are paper, paperboard, cardboard, knitted fabrics, woven fabrics (including so-called tissues) and nonwoven fabrics (including so-called nonwovens). The heat-curable resins used here are inter alia aminoplast resins, more specifically melamine/formaldehyde and urea/formaldehyde precondensates, for example sizes and impregnating resins. On account of their brittleness, these leave something to be desired in terms of the flexibility of the substrates.

WO-A-2008/000665 discloses a process for the finishing of paper and paper products with at least one finishing agent, where at least one finishing agent is applied to the front and/or underside of paper or paper products in the form of a pattern. This process requires smaller amounts of finishing agents compared to known finishing processes in order to produce papers with comparable properties. Suitable finishing agents are inter alia also melamine/formaldehyde resins and urea/formaldehyde resins. Viscosity-improving additives, also-called thickeners, are not specified.

The object of the present invention was therefore to overcome the aforementioned disadvantages, in particular to provide flexible, flat substrates with an abrasive surface for cleaning surfaces, in which the scratching of sensitive surfaces to be cleaned is reduced.

Accordingly, new and improved flexible, flat substrates with a flexible, abrasive surface which comprise 0.1 to 90% by weight of a mixture, based on the uncoated substrate, which comprises the condensation product of 99.985 to 20% by weight of at least one precondensate of a heat-curable resin, 0.005 to 10% by weight of a polymeric thickener selected from the group consisting of biopolymers, associative thickeners and/or completely synthetic thickeners, 0.01 to 10% by weight of a curing agent, 0 to 10% by weight of surface-active substances or surfactants, 0 to 15% by weight of active ingredients and effect substances and 0 to 75% by weight of water, have been found, wherein this mixture comprises 10 to 70% by weight of one or more binders based on the above mixture, from the group of polyacrylates, polymethacrylates, polyacrylonitriles, copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins or mixtures thereof, as have processes for the production thereof and the use thereof.

The flexible, flat substrates according to the invention with a flexible, abrasive surface comprise 0.1 to 90% by weight, preferably 0.25 to 75% by weight, particularly preferably 0.5 to 50% by weight, of a mixture which comprises, in particular consists of, the condensation product of at least one precondensate of a heat-curable resin, a polymeric thickener selected from the group consisting of biopolymers, associative thickeners and/or completely synthetic thickeners, a curing agent and a binder. Possible further components of the mixture are surfactants, additives and active ingredients and effect substances.

These mixtures generally comprise

a) 99.985 to 20% by weight, preferably 80 to 20% by weight, particularly preferably 70 to 20% by weight, of a precondensate of a heat-curable resin,

b) 0.005 to 10% by weight, preferably 0.01 to 5% by weight, particularly preferably 0.1 to 5% by weight, of a polymeric thickener from the group consisting of biopolymers, associative thickeners and/or completely synthetic thickeners or mixtures thereof,

c) 0.01 to 10% by weight, preferably 0.1 to 10% by weight, particularly preferably 0.5 to 10% by weight, of one or more curing agents,

d) 0 to 10% by weight, preferably 0.001 to 5% by weight, particularly preferably 0.001 to 2.5% by weight, of one or more surface-active substances or surfactants,

e) 0 to 15% by weight, preferably 0.001 to 15% by weight, particularly preferably 0.001 to 10% by weight, of active ingredients and effect substances, and mixtures thereof,

f) 0 to 75% by weight, preferably 0 to 70% by weight, particularly preferably 0 to 65% by weight, of water,

and 10 to 70% by weight, preferably 10 to 60% by weight, particularly preferably 10 to 50% by weight, of a binder based on the above mixture.

Within the context of this invention, abrasive surfaces means that these surfaces, when moved over another surface, exert a rubbing and/or scouring effect.

Suitable flexible, flat substrates are, for example, paper, paperboard, cardboard, woven fabrics (including so-called tissues), knitted fabrics and nonwoven fabrics (including so-called nonwovens), preferably paper, paperboard, woven fabrics (including so-called tissues), knitted fabrics and nonwoven fabrics (including so-called nonwovens), particularly preferably paper, woven fabrics (including so-called tissues), knitted fabrics and nonwoven fabrics (including so-called nonwovens).

Paper, paperboard, cardboard packagings and cardboard can be produced from cellulose fibers of all types, either from natural cellulose fibers or from recovered fibers, in particular fibers from waste paper, which are often used in a mixture with fresh fibers (“virgin fibers”). The fibers are suspended in water to give a pulp, from which water is removed on a sieve with sheet formation. Fibrous material that is contemplated for producing the pulps is any grades customary for this purpose in the paper industry, e.g. mechanical pulp, bleached and unbleached chemical pulp, and paper materials from all annual plants. Mechanical pulp includes for example ground wood, thermomechanical pulp (TMP), chemothermomechanical pulp (CTMP), pressure ground wood, semichemical pulp, high-yield pulp and refiner mechanical pulp (RMP). Suitable chemical pulps are, for example, sulfate, sulfite and soda chemical pulps. Preference is given to using unbleached chemical pulp, which is also referred to as unbleached kraft pulp. Suitable annual plants for producing paper materials are, for example, rice, wheat, sugar cane and kenaf. The weight per area of the paper products which constitute the flat substrate for the products according to the invention is, for example, 7.5 to 500 g/m², preferably 10 to 150 g/m², in particular 10 to 100 g/m². Particularly preferred flat substrates are papers made of tissue, and papers which have a structured surface, for example customary kitchen roll in the home. Such paper products have a weight per area, for example, of from 10 to 60 g/m². The flat substrates used can consist of one layer or be composed of a plurality of layers by, for example, superimposing the still-wet layers directly after production and pressing them, or gluing together the already dry layers with the help of appropriate adhesives.

Woven fabrics (including so-called tissues), knitted fabrics and nonwoven fabrics (including so-called nonwovens), which are likewise suitable as flat substrates usually consist of textile fibers or mixtures of textile fibers. Examples thereof are fibers made from cotton, cellulose, hemp, wool, polyamides such as Nylon®, Perlon® or polycaprolactam, polyester and polyacrylonitrile. Examples of tissues and nonwovens are cleaning wipes of all types, for example household cleaning wipes.

The thickness of the flexible, flat substrates according to the invention is generally arbitrary and is in general 0.01 to 1000 mm, preferably 0.02 to 200 mm, particularly preferably 0.03 to 50 mm, in particular 0.04 to 20 mm. It is in most cases in the range from 0.05 to 3 mm. The flat substrates are for example in the form of webs or sheets. Such materials are still flexible even after applying and curing the mixture according to the invention. Although the flexibility of the untreated substrate decreases on account of the application of the heat-curable resin, it is not to the extent that rigid inflexible structures are formed as are customary for example in the case of furniture veneering. Paper or paperboard coated according to the invention are generally not brittle, are also flexible and can be folded without breaking. Cardboard packagings and cardboard coated according to the invention remain flexible and generally have an improved wiping effect compared with an uncoated flexible, flat substrate.

Component a)

Suitable precondensates of a heat-curable resin are melamine/formaldehyde precondensates with a molar ratio of melamine to formaldehyde of from 1:1 to 1:4, preferably from 1:1 to 1:3, particularly preferably from 1:1 to 1:2, examples including the Kauramin® impregnating resins from BASF SE, methanol-etherified melamine/formaldehyde precondensates with a molar ratio of melamines to formaldehyde of from 1:1 to 1:6, preferably from 1:1 to 1:5.5, particularly preferably from 1:1 to 1:5, examples including the Luwipal® coating crosslinkers from BASF SE, urea/formaldehyde precondensates with a molar ratio of urea to formaldehyde of from 1:0.5 to 1:5, preferably from 1:1 to 1:4, particularly preferably from 1:1 to 1:2, examples including the Kaurit® glues from BASF SE, urea/glyoxal precondensates such as the Fixapret® brands from BASF SE, melamine/urea/formaldehyde precondensates such as some Kauramin® or Kaurit® glues from BASF SE, melamine/urea/phenol/formaldehyde precondensates and phenol/formaldehyde precondensates, preferably melamine/formaldehyde precondensates with a molar ratio of melamine to formaldehyde of from 1:1 to 1:4, preferably from 1:1 to 1:3, particularly preferably from 1:1 to 1:2, methanol-etherified melamine/formaldehyde precondensates with a molar ratio of melamines to formaldehyde of from 1:1 to 1:6, preferably from 1:1 to 1:5.5, particularly preferably from 1:1 to 1:5, urea/glyoxal precondensates, melamine/urea/formaldehyde precondensates or urea/formaldehyde precondensates, particularly preferably melamine/formaldehyde precondensates with a molar ratio of melamine to formaldehyde of from 1:1 to 1:4, preferably from 1:1 to 1:3, particularly preferably from 1:1 to 1:2, methanol-etherified melamine/formaldehyde precondensates with a molar ratio of melamines to formaldehyde of from 1:1 to 1:6, preferably from 1:1 to 1:5.5, particularly preferably from 1:1 to 1:5, melamine/urea/formaldehyde precondensates or urea/formaldehyde condensates.

Preference is given to using a precondensate of melamine and formaldehyde in which the molar ratio of formaldehyde to melamine is less than 4:1. As heat-curable resin, preference is given to using a precondensate of melamine and formaldehyde in which the molar ratio of formaldehyde to melamine is 1:1 to 3:1, particularly preferably 1:1 to 2:1. Melamine/formaldehyde condensation products can comprise, besides melamine, 0.01 to 50% by weight, preferably 0.1 to 20% by weight, of “other thermoset formers” (as described below) and, besides formaldehyde, 0.01 to 50% by weight, preferably 0.1 to 20% by weight, of “other aldehydes” (as described below) in condensed-in form.

Suitable “other thermoset formers” are for example alkyl- and aryl-substituted melamine, urea, urethanes, carboxamides, dicyandiamide, guanidine, sulfurylamide, sulfonamides, aliphatic amines, glycols, phenol and phenol derivatives.

“Other aldehydes” which can be used, for example, for the partial replacement of the formaldehyde in the condensates, are acetaldehyde, propionaldehyde, isobutyraldehyde, n-butyraldehyde, trimethylolacetaldehyde, acrolein, benzaldehyde, furfural, glyoxal, glutaraldehyde, phthalaldehyde and terephthalaldehyde.

The precondensates can optionally be etherified with at least one alcohol. Examples thereof are monohydric C₁- to C₁₈-alcohols such as methanol, ethanol, isopropanol, n-propanol, n-butanol, sec-butanol, isobutanol, n-pentanol, cyclopentanol, n-hexanol, cyclohexanol, n-octanol, decanol, palmityl alcohol and stearyl alcohol, polyhydric alcohols such as glycol, diethylene glycol, glycerol, butanediol-1,4, hexanediol-1,6, polyethylene glycols with 3 to 20 ethylene oxide units, unilaterally terminally capped glycols and polyalkylene glycols, propylene glycol-1,2, propylene glycol-1,3, polypropylene glycols, pentaerythritol and trimethylolpropane.

The production of heat-curable resins belongs to the prior art, cf. Ullmann's Encyclopedia of Industrial Chemistry, sixth completely revised edition, Wiley-VCH Verlag GmbH Co. KGaA, Weinheim, “Amino Resins”, vol. 2, pages 537 to 565 (2003).

As a rule, the starting point is an aqueous solution or dispersion of a precondensate, preferably of melamine and formaldehyde. The solids concentration is generally 5 to 95% by weight, preferably 10 to 70% by weight.

Component b)

Suitable polymeric thickeners are biopolymers, associative thickeners, completely synthetic thickeners or mixtures thereof, preferably biopolymers, completely synthetic thickeners or mixtures thereof, particularly preferably biopolymers.

Suitable biopolymers are polysaccharides such as starch, guar seed flour, carob seed flour, agar agar, pectins, gum Arabic, xanthan, proteins such as gelatin, casein or mixtures thereof, preferably polysaccharides such as starch, guar seed flour, carob seed flour, agar agar, pectins, gum Arabic, xanthan, or proteins such as gelatin, casein or mixtures thereof, particularly preferably polysaccharides such as starch, guar seed flour, carob seed flour, agar agar, pectins, gum Arabic, xanthan or mixtures thereof.

Suitable associative thickeners are modified celluloses such as methylcellulose (MC), hydroxyethylcellulose (HEC), hydroxypropylmethylcellulose (HPMC), hydroxypropylcellulose (HPC) and ethylhydroxyethylcellulose (EHEC), modified starches such as hydroxyethyl starch or hydroxypropyl starch, or mixtures thereof, preferably modified celluloses such as methylcellulose (MC), hydroxyethylcellulose (HEC), hydroxypropylmethylcellulose (HPMC), hydroxypropylcellulose (HPC), ethylhydroxyethylcellulose (EHEC) or mixtures thereof.

Suitable completely synthetic thickeners are, for example, polyvinyl alcohols, polyacrylamides, polyvinylpyrrolidone, polyethylene glycols or mixtures thereof.

Component c)

Suitable curing agents are those which catalyze the further condensation of the heat-curable resins, such as acids or salts thereof, and also aqueous solutions of these salts.

Suitable acids are inorganic acids such as HCl, HBr, Hl, H₂SO₃, H₂SO₄, phosphoric acid, polyphosphoric acid, nitric acid, sulfonic acids, for example p-toluenesulfonic acid, methanesulfonic acid, trifluoromethanesulfonic acid, nonafluorobutanesulfonic acid, carboxylic acids such as C₁- to C₈-carboxylic acids, for example formic acid, acetic acid, propionic acid or mixtures thereof, preferably inorganic acids such as HCl, H₂SO₃, H₂SO₄, phosphoric acid, polyphosphoric acid, nitric acid, sulfonic acids such as p-toluenesulfonic acid, methanesulfonic acid, carboxylic acids such as C₁- to C₈-carboxylic acids, for example formic acid, acetic acid, particularly preferably inorganic acids such as H₂SO₄, phosphoric acid, nitric acid, sulfonic acids such as p-toluenesulfonic acid, methanesulfonic acid, carboxylic acids such as formic acid, acetic acid.

Suitable salts are halides, sulfites, sulfates, hydrogensulfates, carbonates, hydrogencarbonates, nitrites, nitrates, sulfonates, salts of carboxylic acids such as formates, acetates, propionates, preferably sulfites, carbonates, nitrates, sulfonates, salts of carboxylic acids such as formates, acetates, propionates, particularly preferably sulfites, nitrates, sulfonates, salts of carboxylic acids such as formates, acetates, propionates, of protonated, primary, secondary and tertiary aliphatic amines, alkanolamines, cyclic, aromatic amines such as C₁- to C₈-amines, isopropylamine, 2-ethylhexylamine, di(2-ethylhexyl)amine, diethylamine, dipropylamine, dibutylamine, diisopropylamine, tert-butylamine, triethylamine, tripropylamine, triisopropylamine, tributylamine, monoethanolamine, morpholine, piperidine, pyridine, and also ammonia, preferably protonated primary, secondary and tertiary aliphatic amines, alkanolamines, cyclic amines, cyclic aromatic amines, and ammonia, particularly preferably protonated alkanolamines, cyclic amines, and ammonia or mixtures thereof.

Salts which may be mentioned are in particular: ammonium chloride, ammonium bromide, ammonium iodide, ammonium sulfate, ammonium sulfite, ammonium hydrogensulfate, ammonium methanesulfonate, ammonium p-toluenesulfonate, ammonium trifluoromethanesulfonate, ammonium nonafluorobutanesulfonate, ammonium phosphate, ammonium nitrate, ammonium formate, ammonium acetate, morpholinium chloride, morpholinium bromide, morpholinium iodide, morpholinium sulfate, morpholinium sulfite, morpholinium hydrogensulfate, morpholinium methanesulfonate, morpholinium p-toluenesulfonate, morpholinium trifluoromethanesulfonate, morpholinium nonafluorobutanesulfonate, morpholinium phosphate, morpholinium nitrate, morpholinium formate, morpholinium acetate, monoethanolammonium chloride, monoethanolammonium bromide, monoethanolammonium iodide, monoethanolammonium sulfate, monoethanolammonium sulfite, monoethanolammonium hydrogensulfate, monoethanolammonium methanesulfonate, monoethanolammonium p-toluenesulfonate, monoethanolammonium trifluoromethanesulfonate, monoethanolammonium nonafluorobutanesulfonate, monoethanolammonium phosphate, monoethanolammonium nitrate, monoethanolammonium formate, monoethanolammonium acetate or mixtures thereof.

The salts are very particularly preferably used in the form of their aqueous solutions. In this connection, aqueous solutions are understood as meaning dilute, saturated, supersaturated and also partially precipitated solutions, and saturated solutions with a solids content of salt that is no longer soluble.

In special cases, the curing agents according to the invention specified for the condensation can also be applied separately to the flat substrate.

The amounts used of the curing agents according to the invention are generally 0.01 to 10% by weight, preferably 0.1 to 10% by weight, particularly preferably 0.5 to 10% by weight, based on the mixture.

Component d)

Suitable surfactants are, for example, all surface-active agents. Examples of suitable nonionic surface-active substances are ethoxylated mono-, di- and trialkylphenols (degree of ethoxylation: 3 to 50, alkyl radical: C₃-C₁₂) and ethoxylated fatty alcohols (degree of ethoxylation: 3 to 80; alkyl radical: C₈-C₃₆). Examples thereof are the Lutensol® brands from BASF SE or the Triton® brands from Union Carbide. Particular preference is given to ethoxylated linear fatty alcohols of the general formula

n-CₓH₂ₓ₊₁—O(CH₂CH₂O)_{y}—H,

where x is integers in the range from 10 to 24, preferably in the range from 12 to 20. The variable y is preferably integers in the range from 5 to 50, particularly preferably 8 to 40. Ethoxylated linear fatty alcohols are usually in the form of a mixture of different ethoxylated fatty alcohols with a different degree of ethoxylation. Within the context of the present invention, the variable y is the average value (number average). Suitable nonionic surface-active substances are also copolymers, in particular block copolymers of ethylene oxide and at least one C₃-C₁₀-alkylene oxide, e.g. triblock copolymers of the formula

RO(CH₂CH₂O)_{y1}—(BO)_{y2}-(A-O)ₘ—(B′O)_{y3}—(CH₂CH₂O)_{y4}R′,

where m is 0 or 1, A is a radical derived from an aliphatic, cycloaliphatic or aromatic dial, e.g. ethane-1,2-diyl, propane-1,3-diyl, butane-1,4-diyl, cyclohexane-1,4-diyl, cyclohexane-1,2-diyl or bis(cyclohexyl)methane-4,4′-diyl, B and B′, independently of one another, are propane-1,2-diyl, butane-1,2-diyl or phenylethenyl independently of one another a number from 2 to 100 and y2, y3 independently of one another are a number from 2 to 100, where the sum y1+y2+y3+y4 is preferably in the range from 20 to 400, which corresponds to a number-average molecular weight in the range from 1000 to 20 000. Preferably, A is ethane-1,2-diyl, propane-1,3-diylor butane-1,4-diyl. B is preferably propane-1,2-diyl.

Suitable surface-active substances are furthermore polyalkylene glycols substituted with fluorine such as, for example, Zonyl® or Capstone® (DuPont).

Apart from the nonionic surfactants, also anionic and cationic surfactants are contemplated as surface-active substances. They can be used alone or as a mixture. A prerequisite for this, however, is that they are compatible with one another, i.e. do not produce any sediments with one another. This prerequisite is applicable, for example, for mixtures from one of each compound class, and also for mixtures of nonionic and anionic surfactants and mixtures of nonionic and cationic surfactants. Examples of suitable anionic surface-active agents are sodium lauryl sulfate, sodium dodecyl sulfate, sodium hexadecyl sulfate and sodium dioctyl sulfosuccinate. Furthermore, it is also possible to use esters of phosphoric acid or of phosphorous acid, and aliphatic or aromatic carboxylic acids as anionic emulsifiers.

Examples of cationic surfactants are quaternary alkylammonium salts, alkylbenzylammonium salts, such as dimethyl-C₁₂-C₁₈-alkylbenzylammonium chlorides, primary, secondary and tertiary fatty amine salts, quaternary amidoamine compounds, alkylpyridinium salts, alkylimidazolinium salts and alkyloxazolinium salts.

Customary emulsifiers are described in detail in the literature, see, for example, M. Ash, I. Ash, Handbook of Industrial Surfactants, third edition, Synapse Information Resources Inc.

The aqueous solution or dispersion can comprise one or more surface-active substances or surfactants in amounts of from 0 to 10% by weight, preferably 0.001 to 5% by weight, particularly preferably 0.001 to 2.5% by weight.

Component e)

As well as the aforementioned customary additives such as thickeners, curing agents and surfactants, or instead of the aforementioned customary additives, the flexible, flat substrates according to the invention, for example, paper, paperboard, cardboard, woven fabrics (including so-called tissues), knitted fabrics and nonwoven fabrics (including so-called nonwovens), preferably fabrics (including so-called tissues), knitted fabrics and nonwoven fabrics (including so-called nonwovens), can also comprise active ingredients and effect substances, preferably in an amount in the range from 0 to 15% by weight, preferably 0.001 to 15% by weight, particularly preferably 0.001 to 10% by weight, in particular 0.01 to 10% by weight, very particularly preferably 0.01 to 1% by weight.

Such active ingredients and effect substances are preferably fragrances, dyes or pigments, waxes, surfactants, surface-active substances, amphiphilic polymers, care agents for surfaces, shine-producing substances, antibacterial finishing agents, biocides, silver ions, nanoparticles, and silicones.

Suitable dyes or pigments are inorganic and organic dyes or pigments, such as azo pigments and dyes, and polycyclic pigments, particularly copper phthalocyanine, indanthrene, polychlorocopper phthalocyanine, perylenes.

The active ingredients and effect substances, preferably volatile active ingredients and effect substances such as fragrances, or else water-insoluble active ingredients and effect substances, such as waxes or silicones, can be present in encapsulated form, preferably in microcapsules.

The active ingredients and effect substances can be applied to or in the flexible, flat substrates according to the invention in any desired manner. They are preferably applied to the flat substrates in the same process step as the resin. They are particularly preferably used as part of the resin solution or dispersion.

Component f)

Water can be added in amounts of from 0 to 75% by weight or 0 to 79.985% by weight, preferably 0 to 70% by weight, particularly preferably 0 to 65% by weight, in addition to the water present in the aqueous components used.

Suitable binders are polyacrylates, polymethacrylates, polyacrylonitriles, and copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins or mixtures thereof, preferably aqueous binders of polyacrylates, polymethacrylates, polyacrylonitriles, and copolymers of acrylic acid esters and acrylonitrile, styrene and acrylonitrile, acrylic acid esters and styrene and acrylonitrile, acrylonitrile and butadiene and styrene, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins or mixtures thereof, particularly preferably aqueous binders of polyacrylates, polymethacrylates, polyacrylonitriles, and copolymers of acrylic acid esters and acrylonitrile, styrene and acrylonitrile, acryl acid esters and styrene and acrylonitrile, acrylonitrile and butadiene and styrene, polyurethanes, melamine-formaldehyde resins, melamine-urea-formaldehyde resins or mixtures thereof, in particular aqueous binders of polyacrylates, polymethacrylates, polyacrylonitriles, and copolymers of acrylic acid esters and acrylonitrile, styrene and acrylonitrile, acryl acid esters and styrene and acrylonitrile, acrylonitrile and butadiene and styrene, polyurethanes, melamine-formaldehyde resins, melamine-urea-formaldehyde resins or mixtures thereof.

Polyacrylates, polymethacrylates, polyacrylonitriles, and copolymers of acrylic acid esters and acrylonitrile, styrene and acrylonitrile, acrylic acid esters and styrene and acrylonitrile, acrylonitrile and butadiene and styrene can be obtained by free-radical polymerization of ethylenically unsaturated compounds (monomers) according to generally known processes, as are known for example from Vana, P., Barner-Kowollik, C., Davis, T. P. and Matyjaszewski, K. 2003. Radical Polymerization Encyclopedia of Polymer Science and Technology; van Herk, A. and Heuts, H. 2009. Emulsion Polymerization. Encyclopedia of Polymer Science and Technology; D. C. Blackley, in High Polymer Latices, vol. 1, page 35 ff. (1966); H. Warson, The Applications of Synthetic Resin Emulsions, chapter 5, page 246 ff. (1972); D. Diederich, Chemie in unserer Zeit [Chemistry in our time], 24, pages 135 to 142 (1990); Emulsion Polymerisation, Interscience Publishers, New York (1965); DE-A-40 03 422 and Dispersionen synthetischer Hochpolymerer [Dispersions of synthetic high polymers], F. Hölscher, Springer-Verlag, Berlin, page 35 ff. (1969).

Polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins can be obtained by polycondensation by generally known processes, as are known for example from Ullmann's Encyclopedia of Industrial Chemistry, sixth completely revised edition, Wiley-VCH Verlag GmbH Co. KGaA, Weinheim, “Amino Resins”, vol. 2, pages 537 to 565 (2003) for melamine-formaldehyde resins, phenol-formaldehyde resins, urea-formaldehyde resins, melamine-urea-formaldehyde resins, melamine-urea-phenol-formaldehyde resins, urea-glyoxal resins or DE-A-10161156 for polyurethanes.

Particularly preferred binders are the Acronal®, Acrodur®, Emuldur® or Luphen® brands from BASF SE.

Aqueous binder composition based on polymers which have been obtained by free-radical polymerization of ethylenically unsaturated compounds (monomers) comprising in general as essential binder components

i. at least one polymer P, composed of
≧0.1 and ≦15% by weight of at least one acid-group-containing ethylenically unsaturated monomer and/or at least one α,β-monoethylenically unsaturated C₃- to C₆-mono- or dicarboxamide (monomers A)
≧8 and ≦30% by weight of at least one ethylenically unsaturated carbonitrile or dinitrile (monomers B)
≧0 and ≦5% by weight of at least one crosslinking monomer with at least two nonconjugated ethylenically unsaturated groups (monomers C)
≧0 and ≦10% by weight of at least one monoethylenically unsaturated silane-group-containing compound (monomers D)
≧20 and ≦70% by weight of at least one ethylenically unsaturated monomer, the homopolymer of which has a glass transition temperature of ≦30° C. (monomers E) and which differs from monomers A to D, and
≧25 and ≦71.9% by weight of at least one ethylenically unsaturated monomer, the homopolymer of which has a glass transition temperature of ≧50° C. (monomers F) and which differs from monomers A to D,
in polymerized-in form, where the amounts of monomers A to F add up to 100% by weight, and

ii. at least one saccharide compound S, its amount being such that it is ≧10 and ≦400 parts by weight per 100 parts by weight of polymer P, and

where the total amount of additional formaldehyde-containing binder components is ≦50 parts by weight per 100 parts by weight of the sum of the total amounts of polymer P and saccharide compound S.

An essential constituent of the aqueous binder composition is a polymer P, which is composed, in polymerized-in form, of

≧0.1 and ≦15% by weight of at least one acid-group-containing ethylenically unsaturated monomer and/or at least one α,β-monoethylenically unsaturated C₃- to C₆-mono- or dicarboxamide (monomers A)

≧8 and ≦30% by weight of at least one ethylenically unsaturated carbonitrile or -dinitrile (monomers B)

≧0 and ≦5% by weight of at least one crosslinking monomer with at least two nonconjugated ethylenically unsaturated groups (monomers C)

≧0 and ≦10% by weight of at least one monoethylenically unsaturated silane-group-containing compound (monomers D)

≧20 and ≦70% by weight of at least one ethylenically unsaturated monomer, the homopolymer of which has a glass transition temperature of ≦30° C. (monomers E) and which differs from monomers A to D, and

≧25 and ≦71.9% by weight of at least one ethylenically unsaturated monomer, the homopolymer of which has a glass transition temperature of ≧50° C. (monomers F) and which differs from monomers A to D.

Suitable monomers A are all ethylenically unsaturated compounds which have at least one acid group [proton donor], such as, for example, a sulfonic acid, phosphonic acid or carboxylic acid group, such as, for example, vinylsulfonic acid, allylsulfonic acid, styrenesulfonic acid, 2-acrylamidomethylpropanesulfonic acid, vinylphosphonic acid, allylphosphonic acid, styrenephosphonic acid and 2-acrylamido-2-methylpropanephosphonic acid. However, the monomers A are advantageously a,8-monoethylenically unsaturated, in particular C₃- to C₆-, preferably C₃- or C₄-mono- or dicarboxylic acids such as, for example, acrylic acid, methacrylic acid, ethylacrylic acid, itaconic acid, allylacetic acid, crotonic acid, vinylacetic acid, fumaric acid, maleic acid, 2-methylmaleic acid. However, the monomers A also comprise the anhydrides of corresponding α,β-monoethylenically unsaturated dicarboxylic acids, such as, for example, maleic anhydride or 2-methylmaleic anhydride. Preferably, the acid-group-containing monomer A is selected from the group comprising acrylic acid, methacrylic acid, crotonic acid, fumaric acid, maleic acid, maleic anhydride, 2-methylmaleic acid and itaconic acid, with acrylic acid, methacrylic acid and/or itaconic acid being particularly preferred. The monomers A also of course comprise the completely or partially neutralized water-soluble salts, in particular the alkali metal or ammonium salts, of the aforementioned acids.

Suitable monomers A moreover are all α,β-monoethylenically unsaturated C₃- to C₆-mono- or dicarboxamides. The monomers A likewise include the aforementioned compounds, whose carboxamide group is substituted with an alkyl or a methylol group. Examples of such monomers A are the amides and diamides of the α,β-monoethylenically unsaturated C₃- to C₆-, preferably C₃- or C₄-mono- or dicarboxylic acids such as, for example, acrylamide, methacrylamide, ethylacrylic acid amide, itaconic acid mono- or diamide, allylacetic acid amide, crotonic acid mono- or diamide, vinylacetic acid amide, fumaric acid mono- or diamide, maleic acid mono- or diamide, and 2-methylmaleic acid mono- or diamide. Examples of α,β-monoethylenically unsaturated C₃- to C₆-mono- or dicarboxylic acid amides whose carboxylic acid amide group are substituted with an alkyl or a methylol group are N-alkylacrylamides and -methacrylamides, such as, for example, N-tert-butylacrylamide and -methacrylamide, N-methylacrylamide and -methacrylamide, and N-methyloacrylamide and N-methylolmethacrylamide. Preferred amidic monomers A are acrylamide, methacrylamide. N-methylolacrylamide and/or N-methylolmethacrylamide, with methylolacrylamide and/or N-methylolmethacrylamide being particularly preferred.

Monomers A are particularly preferably acrylic acid, methacrylic acid, crotonic acid, fumaric acid, maleic acid, maleic anhydride, 2-methylmaleic acid, itaconic acid, acrylamide, methacrylamide. N-methylolacrylamide and/or N-methylolmethacrylamide, with acrylic acid, methacrylic acid, itaconic acid, methylolacrylamide and/or N-methylolmethacrylamide being particularly preferred.

The amount of monomers A polymerized in the polymer P is ≧0.1 and ≦15% by weight, preferably ≧0.5 and ≦10% by weight and particularly preferably ≧3 and ≦8.5% by weight.

Suitable monomers B are all ethylenically unsaturated compounds which have at least one nitrile group. However, the monomers B are advantageously the nitriles, which are derived from the aforementioned α,β-monoethylenically unsaturated, in particular C₃- to C₆-, preferably C₃- or C₄-mono- or dicarboxylic acids, such as, for example, acrylonitrile, methacrylonitrile, maleic acid dinitrile and/or fumaric acid dinitrile, with acrylonitrile and/or methacrylonitrile being particularly preferred.

The amount of monomers B polymerized in the polymer P is ≧8 and ≦30% by weight, preferably ≧10 and ≦25% by weight and particularly preferably ≧10 and ≦20% by weight.

Suitable monomers C are all compounds which have at least two nonconjugated ethylenically unsaturated groups. Examples thereof are monomers having two vinyl radicals, monomers having two vinylidene radicals, and monomers having two alkenyl radicals. Of particular advantage here are the diesters of dihydric alcohols with α,β-monoethylenically unsaturated monocarboxylic acids, among which acrylic acid and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylate and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, triesters of trihydric alcohols with α,β-monoethylenically unsaturated monocarboxylic acids, such as, for example, glycerol triacrylate, glycerol trimethacrylate, trimethylolpropane triacrylate, trimethylolpropane trimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Particular preference is given to 1,4-butylene glycol diacrylate, allyl methacrylate and/or divinylbenzene.

The amount of monomers C polymerized in the polymer P is ≧0 and ≦5% by weight, preferably ≧0 and ≦3% by weight and particularly preferably ≧0 and ≦1.5% by weight.

Suitable monomers D are all monoethylenically unsaturated silane-group-containing compounds. With particular advantage, the monomers D have a hydrolyzable silane group. Hydrolyzable silane groups advantageously comprise at least one alkoxy group or one halogen atom, such as, for example, chlorine. Monomers D that can be used advantageously are disclosed in WO-A-2008/150647, page 9, lines 5 to 25. 3-Methacryloxypropyltrimethoxysilane, 3-methacryloxypropyltriethoxysilane, vinyltriacetoxysilane and/or vinylethoxydimethoxysilane are used particularly advantageously. In this connection, the monomers D are always preferably used if inorganic granular and/or fibrous substrates, such as in particular glass fibers or mineral fibers, for example, asbestos or rock wool, are to be bonded.

The amount of monomers D optionally polymerized in the polymer P is, in a preferred embodiment, ≧0 and ≦10% by weight, preferably ≧0 and ≦5% by weight and particularly preferably 0% by weight. In another preferred embodiment, particularly if inorganic granular and/or fibrous substrates are to be bonded, the amount of monomers D polymerized in the polymer P is ≧0.1 and ≦10% by weight, advantageously ≧0.1 and ≦5% by weight and particularly advantageously ≧0.5 and ≦2.5% by weight.

Suitable monomers E are all ethylenically unsaturated monomers whose homopolymer have a glass transition temperature ≦30° C. and which differ from monomers A to D. Suitable monomers E are, for example, conjugated aliphatic C₄- to C₉-diene compounds, esters of vinyl alcohol and a C₁- to C₁₀ -monocarboxylic acid, C₁- to C₁₀-alkyl acrylate, C₅- to C₁₀-alkyl methacrylate, C₅- to C₁₀-cycloalkyl acrylate and methacrylate, C₁- to C₁₀-dialkyl maleate and/or to C₁₀-dialkyl fumarate, vinyl ethers of C₃- to C₁₀-alkanols, branched and unbranched C₃ to C₁₀-olefins. Those monomers E whose homopolymers have Tg values <0° C. are advantageously used. The monomers E used are particularly advantageously vinyl acetate, ethyl acrylate, n-propyl acrylate, n-butyl acrylate, isobutyl acrylate, sec-butyl acrylate, n-hexyl acrylate, 2-ethylhexyl acrylate, n-hexyl methacrylate, 2-ethylhexyl methacrylate, di-n-butyl maleate, di-n-butyl fumarate, with 2-ethylhexyl acrylate, n-butyl acrylate, 1,4-butadiene and/or ethyl acrylate being particularly preferred.

The amount of monomers E polymerized in the polymer P is ≧20 and ≦70% by weight, preferably ≧25 and ≦65% by weight and particularly preferably ≧30 and ≦60% by weight.

Suitable monomers F are all ethylenically unsaturated monomers whose homopolymer have a glass transition temperature ≧50° C. and which differ from monomers A to D. Suitable monomers F are, for example, vinylaromatic monomers and C₁- to C₄-alkyl methacrylates. Vinylaromatic monomers are understood as meaning in particular derivatives of styrene or of α-methylstyrene, in which the phenyl rings are optionally substituted by 1, 2 or 3 C₁- to C₄-alkyl groups, halogen, in particular bromine or chlorine, and/or methoxy groups. Preference is given to those monomers whose homopolymers have a glass transition temperature ≧80° C. Particularly preferred monomers are styrene, α-methylstyrene, o- or p-vinyltoluene, p-acetoxystyrene, p-bromostyrene, p-tert-butylstyrene, o-, m- or p-chlorostyrene, methyl methacrylate, tert-butyl acrylate, tert-butyl methacrylate, ethyl methacrylate, isobutyl methacrylate, n-hexyl acrylate, cyclohexyl methacrylate, but, for example, also tert-butyl vinyl ether or cyclohexyl vinyl ether, but with methyl methacrylate, styrene and/or tert-butyl methacrylate being particularly preferred.

The amount of monomers F polymerized in the polymer P is ≧25 and ≦71.9% by weight, preferably ≧25 and ≦64.5% by weight and particularly preferably ≧25 and ≦57% by weight.

Aqueous binder composition comprising a polyurethane composed of

1a) diisocyanates,

1b) diols, of which
1b₁) 10 to 100 mol %, based on the total amount of diols (1b), have a molecular weight of from 500 to 5000, and
1b₂) 0 to 90 mol %, based on the total amount of diols (1b), have a molecular weight of from 60 to 500 g/mol,

1c) monomers that are different from monomers (1a) and (1b) and have at least one isocyanate group or at least one group that is reactive towards isocyanate groups, and which moreover carry at least one hydrophilic group or one potentially hydrophilic group, as a result of which the dispersability of the polyurethanes in water is effected,

1d) optionally further polyvalent compounds that are different from monomers (1a) to (1c) and have reactive groups which are alcoholic hydroxyl groups, primary or secondary amino groups or isocyanate groups and

1e) optionally monovalent compounds that are different from monomers (1a) to (1d) and have a reactive group which is an alcoholic hydroxyl group, a primary or secondary amino group or an isocyanate group,

obtainable by reacting monomers 1a), 1b), 1c) and optionally 1d) and 1e) in the presence of a suitable catalyst.

The aqueous dispersions comprise polyurethanes which are derived from diisocyanates 1a) as well as other monomers, preference being given to using those diisocyanates 1a) which are usually used in polyurethane chemistry.

As monomers, mention is to be made in particular of

1a) diisocyanates X(NCO)₂, where X is an aliphatic hydrocarbon radical having 4 to 12 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, cis/cis and cis/trans isomers, and mixtures consisting of these compounds.

Diisocyanates of this type are commercially available,

Important mixtures of these isocyanates are particularly the mixtures of the respective structural isomers of diisocyanatotoluene and diisocyanatodiphenylmethane, the mixture of 80 mol % of 2,4-diisocyanatotoluene and 20 mol % of 2,6-diisocyanatotoluene being particularly suitable. Furthermore, the mixtures of aromatic isocyanates such as 2,4-diisocyanatotoluene and/or 2,6-diisocyanatotoluene with aliphatic or cycloaliphatic isocyanates such as hexamethylene diisocyanate or IPDI are particularly advantageous, in which case the preferred mixing ratio of the aliphatic to aromatic isocyanates is 4:1 to 0.25:1.

For building up the polyurethanes, compounds that can be used apart from those mentioned above are also isocyanates which, besides the free isocyanate groups, carry further capped isocyanate groups, e.g. uretdione groups.

As regards good film formation and elasticity, suitable diols are

1b) primarily higher molecular weight diols (b₁) which have a molecular weight of from 500 to 5000 g/mol, preferably from 1000 to 3000 g/mol.

The diols (1b₁) are in particular polyester polyols which are known, e.g. from Ullmann's Encyclopedia of Industrial Chemistry, 4th edition, volume 19, pages 62 to 65. Preference is given to using polyester polyols which are obtained by reacting dihydric alcohols with dibasic carboxylic acids. Instead of the free polycarboxylic acids, it is also possible to use the corresponding polycarboxylic anhydrides or corresponding polycarboxylic acid esters of lower alcohols or mixtures thereof for preparing the polyester polyols. The polycarboxylic acids may be aliphatic, cycloaliphatic, araliphatic, aromatic or heterocyclic and be optionally e.g. halogen-substituted and/or unsaturated. Examples thereof include: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric fatty acids. Preference is given to dicarboxylic acids of the general formula HOOC—(CH₂)_{y}—COOH, where y is a number from 1 to 20, preferably an even number from 2 to 20, e.g. succinic acid, adipic acid, sebacic acid and dodecanedicarboxylic acid.

Suitable polyhydric alcohols are e.g. ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentane diols, also diethylene glycol, triethylene glycol, tetraethylene glycol, polyethylene glycol, dipropylene glycol, polypropylene glycol, dibutylene glycol and polybutylene glycols. Preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol and dodecane-1,12-diol. Furthermore, preference is given to neopentyl glycol.

Of suitability are furthermore also polycarbonate diols, as can be obtained e.g. by reacting phosgene with an excess of the low molecular weight alcohols specified as structural components for the polyester polyols.

Also of suitability are polyester diols based on lactone, which are homopolymers or mixed polymers of lactones, preferably addition products having terminal hydroxyl groups, of lactones onto suitable difunctional starter molecules. Suitable lactones are preferably those which are derived from compounds of the general formula HO—(CH₂)_{z}—COOH, where z is a number from 1 to 20 and an H atom of a methylene unit can also be substituted by a C₁- to C₄-alkyl radical. Examples are ε-caprolactone, β-propiolactone, γ-butyrolactone and/or methyl-ε-caprolactone, and mixtures thereof. Suitable starter components are, e.g. the low molecular weight dihydric alcohols specified above as structural component for the polyester polyols. The corresponding polymers of ε-caprolactone are particularly preferred. Lower polyester diols or polyether diols can also be used as starters for preparing the lactone polymers. Instead of the polymers of lactones, it is also possible to use the corresponding, chemically equivalent polycondensates of the hydroxycarboxylic acids corresponding to the lactones.

In addition, suitable monomers (1b₁) are polyether diols. They are obtainable in particular by polymerization of ethylene oxide, propylene oxide, butylene oxide, tetrahydrofuran, styrene oxide or epichlorohydrin with themselves, e.g. in the presence of BF₃ or as a result of the addition of these compounds optionally in the mixture, or successively, onto starting components with reactive hydrogen atoms, such as alcohols or amines, e.g. water, ethylene glycol, propane-1,2-diol, propane-1,3-diol, 1,2-bis(4-hydroxydiphenyl)propane or aniline. Particular preference is given to polytetrahydrofuran with a molecular weight of from 240 to 5000, and in particular 500 to 4500. In addition, mixtures of polyester diols and polyether diols can also be used as monomers (1b₁).

Likewise of suitability are polyhydroxy olefins, preferably those with 2 terminal hydroxyl groups, e.g. α-ω-dihydroxypolybutadiene, α-ω-dihydroxypolymethacrylate or α-ω-dihydroxypolyacrylate as monomers (1c₁). Such compounds are known, for example, from EP-A-622378. Further suitable polyols are polyacetals, polysiloxanes and alkyd resins.

The polyols can also be used as mixtures in the ratio 0.1:1 to 9:1.

The monomers (1b₂) used are primarily the structural components of the short-chain alkane diols specified for the preparation of polyester polyols, preference being given to diols having 2 to 12 carbon atoms, unbranched diols having 2 to 12 carbon atoms and an even number of carbon atoms, and pentane-1,5-diol and neopentyl glycol.

Preferably, the fraction of the diols (1b₁), based on the total amount of diols (1b), is 10 to 100 mol % and the fraction of the monomers (b₂), based on the total amount of the diols (1b), is 0 to 90 mol %. Particularly preferably, the ratio of the dials (1b₁) to the monomers (1b₂) is 0.1:1 to 5:1, particularly preferably 0.2:1 to 2:1.

In order to achieve the dispersability of the polyurethanes in water, the polyurethanes are composed, besides components (1a), (1b) and optionally (1d), of monomers (1c) that are different from components (1a), (1b) and (1d), and which carry at least one isocyanate group or at least one group that is reactive toward isocyanate groups and moreover at least one hydrophilic group or a group which can be converted to a hydrophilic group. Hereinbelow, the term “hydrophilic groups or potentially hydrophilic groups” is abbreviated to “(potentially) hydrophilic groups”. The (potentially) hydrophilic groups react with isocyanates considerably more slowly than the functional groups of the monomers which serve for constructing the polymer main chain.

The fraction of the components with (potentially) hydrophilic groups of the total amount of components (1a), (1b), (1c), (1d) and (1e) is generally such that the molar amount of the (potentially) hydrophilic groups, based on the amount by weight of all monomers (1a) to (1e), is 30 to 1000 mmol/kg, preferably 50 to 500 mmalikg and particularly preferably 80 to 300 mmol/kg.

(Potentially) ionic monomers (1c) are described in detail e.g. in Ullmann's Encyclopedia of Industrial Chemistry, 4th edition, volume 19, pages 311 to 313 and for example in DE-A-14 95 745.

Of particular practical importance as (potentially) cationic monomers (1c) are, in particular, monomers with tertiary amino groups, for example: tris(hydroxyalkyl)amines, N,N′-bis(hydroxyalkyl)alkylamines, alkylamines, N-hydroxyalkyl-1-dialkylamines, tris(aminoalkyl)amines, N,N′-bis(aminoalkyl)alkylamines, N-aminoalkyldialkylamines, where the alkyl radicals and alkanediyl units of these tertiary amines consist independently of one another of 1 to 6 carbon atoms. Also of suitability are polyethers having tertiary nitrogen atoms and preferably two terminal hydroxyl groups, as are accessible e.g. by alkoxylation of amines having two hydrogen atoms bonded to amine nitrogen, e.g. methylamine, aniline or N,N′-dimethylhydrazine, in a manner customary per se. Polyethers of this type generally have a molar weight between 500 and 6000 g/mol.

These tertiary amines are converted to the ammonium salts either with acids, preferably strong mineral acids such as phosphoric acid, sulfuric acid, hydrohalic acids, or strong organic acids, or by reaction with suitable quaternizing agents such as C₁- to C₆-alkyl halides or benzyl halides, e.g. bromides or chlorides.

Suitable monomers with (potentially) anionic groups are usually aliphatic, cycloaliphatic, araliphatic or aromatic carboxylic acids and sulfonic acids which carry at least one alcoholic hydroxyl group or at least one primary or secondary amino group, Preference is given to dihydroxyalkylcarboxylic acids, primarily having 3 to 10 carbon atoms, as are also described in U.S. Pat. No. 3,412,054.

Otherwise of suitability are dihydroxyl compounds with a molecular weight above 500 to 10 000 g/mol with at least 2 carboxylate groups which are known from DE-A-39 11 827. They are obtainable by reacting dihydroxyl compounds with tetracarboxylic dianhydrides such as pyromellitic dianhydride or cyclopentanetetracarboxylic dianhydride in the molar ratio 2:1 to 1.05:1 in a polyaddition reaction. Suitable dihydroxyl compounds are in particular the monomers (1b₂) and the diols (1b₁) listed as chain extenders.

Suitable monomers (1c) with amino groups that are reactive toward isocyanates are aminocarboxylic acids such as lysine, β-alanine or the adducts, given in DE-A-20 34 479, of aliphatic diprimary diamines onto α,β-unsaturated carboxylic acids or sulfonic acids.

Particular preference is given to N-(2-aminoethyl)-2-aminoethanecarboxylic acid and N-(2-aminoethyl)-2-aminoethanesulfonic acid or the corresponding alkali metal salts, with Na being particularly preferred as counterion.

Furthermore, preference is given to the adducts of the aforementioned aliphatic diprimary diamines onto 2-acrylamido-2-methylpropanesulfonic acid, as described, e.g. in the DE patent specification 19 54 090.

The polyurethanes comprise preferably 1 to 30, particularly preferably 4 to 25 mol %, based on the total amount of components (1b) and (1d) of a polyamine with at least 2 amino groups that are reactive toward isocyanates as monomers (1d).

Monomers (1e), which are optionally co-used, are monoisocyanates, monoalcohols and monoprimary and monosecondary amines. In general, their fraction is at most 10 mol %, based on the total molar amount of the monomers. These monofunctional compounds usually carry further functional groups such as olefinic groups or carbonyl groups and serve for introducing functional groups into the polyurethane, which permit the dispersion and/or the crosslinking or other polymer-analogous reaction of the polyurethane. Of suitability for this are monomers such as isoprenyl α,α-dimethylbenzylisocyanate (TMI) and esters of acrylic acid or methacrylic acid such as hydroxyethyl acrylate or hydroxyethyl methacrylate.

Normally, the components (1a) to (1e) and their respective molar amounts are selected such that the ratio A:B is 0.5:1 to 2:1, preferably 0.8:1 to 1.5:1, particularly preferably 0.9:1 to 1.2:1. Very particularly preferably, the ratio A:B is as close as possible to 1:1, in which

A) means the molar amount of isocyanate groups and

B) means the sum of the molar amount of hydroxyl groups and the molar amount of functional groups which can react with isocyanates in an addition reaction.

The monomers (1a) to (1e) used carry on average usually 1.5 to 2.5, preferably 1.9 to 2.1, particularly preferably 2, isocyanate groups or functional groups which can react with isocyanates in an addition reaction.

The polyaddition of monomers 1a), 1b), 1c) and optionally 1d) and 1e) for preparing the PU dispersion takes place in the presence of a suitable catalyst.

Suitable catalysts are tin compounds, for example dibutyltin dilaurate, also tertiary amines, and compounds of zinc, zirconium, copper, bismuth, titanium, molybdenum, and cesium.

Q. Bell, Raw Materials and their Usage, in: Solvent-Borne Urethane Resins, Vol. 1: Surface Coatings, Chapman and Hall, New York, 1993, p. 153 ff., describes various aminic and metal-based catalysts.

Preferred cesium compounds are cesium salts, in which the following anions are used: F, Cl⁻, ClO⁻, ClO₃, CLO₄, Br⁻, J⁻, JO₃⁻, CN⁻, OCN⁻, NO₂⁻, NO₃⁻, HCO₃⁻CO₃²⁻, S²⁻, SH⁻, HSO₃⁻, SO₃²⁻, HSO₄⁻, S₂O₂²⁻, S₂O₄²⁻, S₂O₅²⁻, S₂O₆²⁻, S₂O₇²⁻, S₂O₈²⁻, H₂PO₂⁻, H₂PO₄₋, HPO₄₋, PO₄³⁻, P₂O₇⁴⁻, (OCₙH₂ₙ₊₁)⁻, (CₙH₂ₙ₋₁O₂)⁻, (Cₙ₊₁H₂ₙ₋₂O₄)²⁻, where n is numbers 1 to 20.

Particular preference is given to here to cesium carboxylates in which the anion obeys the formulae (CₙH₂ₙ₋₁O₂)⁻ and (Cₙ₊₁H₂ₙ₋₂O₄)²⁻ where n is 1 to 20. Very particularly preferred cesium salts have, as anions, monocarboxylates of the general formula (CₙH₂ₙ₋₁O₂)⁻, where n is numbers 1 to 20. Particular mention should be made here of formate, acetate, propionate, hexanoate and 2-ethylhexanoate.

The cesium salts are used in amounts of from 0.01 to 10 mmol of cesium salt per kg of solvent-free mixture. Preferably, they are used in amounts of from 0.05 to 2 mmol of cesium salt per kg of solvent-free mixture.

The dispersions generally have a solids content of from 10 to 75, preferably from 20 to 65% by weight and a viscosity of from 10 to 500 mPas (measured at a temperature of 20° C. and a shear rate of 250 s⁻¹).

Such aqueous polyurethane dispersions are described, for example in DE-A-101 61 156.

The aqueous solution or dispersion of a precondensate of a heat-curable resin and of a binder can optionally also comprise a surfactant. Of suitability are, for example, nonionic, anionic and cationic surfactants, and mixtures of at least one nonionic and at least one anionic surfactant, mixtures of at least one nonionic and at least one cationic surfactant, mixtures of two or more nonionic or of two or more cationic or of two or more anionic surfactants.

The flexible, flat substrates according to the invention can be produced as follows;

The flat substrates such as nonwoven fabrics (including so-called nonwovens), woven fabrics (including so-called tissues), knitted fabrics, paper, paperboard and cardboard can be firstly treated with an aqueous solution or dispersion of a precondensate of at least one heat-curable resin and a binder.

The solution or dispersion of the precondensate and of the binder can comprise a curing agent, but can also be used without curing agents.

Processes for producing flexible, flat substrates with an abrasive surface can be carried out by applying an aqueous solution or dispersion of at least one precondensate of a heat-curable resin and of a binder to the top and/or bottom of a flexible, flat substrate in an amount in the range from 0.1 to 90% by weight, based on the uncoated, dry substrate, then crosslinking the precondensate and drying the treated substrate.

In a highly suitable process, the active ingredients and effect substances, preferably dyes or pigments or unencapsulated or (micro)encapsulated fragrances, are added to the finished aqueous solution or dispersion of the precondensate and of the binder before it is applied to the flat substrate, preferably paper, paperboard, cardboard, woven fabrics (including so-called tissues), knitted fabrics and nonwoven fabrics (including so-called nonwovens).

In a further highly suitable process, the active ingredients and effect substances, preferably dyes or pigments or unencapsulated or (micro)encapsulated fragrances, are added during the preparation of the aqueous solution or dispersion of the precondensate and of the binder, and said solution or dispersion is then applied to the flat substrate, preferably paper, paperboard, cardboard, woven fabrics (including so-called tissues), knitted fabrics and nonwoven fabrics (including so-called nonwovens).

In a further highly suitable process, the active ingredients and effect substances, preferably dyes or pigments or unencapsulated or (micro)encapsulated fragrances, are added during the preparation of the precondensate and of the binder. Then, only shortly before application to the flat substrate is this mixture converted to an aqueous solution or dispersion and then applied to the flat substrate, preferably paper, paperboard, cardboard, woven fabrics (including so-called tissues), knitted fabrics and nonwoven fabrics (including so-called nonwovens).

Usually, the specified active ingredients and effect substances, preferably the (micro)encapsulated active ingredients and effect substances, particularly preferably the (micro)encapsulated volatile active ingredients and effect substances, such as fragrances and/or water-insoluble active ingredients and effect substances, such as waxes or silicones are partly or completely released upon mechanical stressing, such as scouring, wiping or other cleaning, of the flexible, flat substrates according to the invention.

In order to achieve a good and as uniform as possible distribution of the resin and of the binder, preferably on the surface of the substrate and not in its deeper layers, during the resin application, a certain rheological behavior or a certain viscosity of the aqueous solution or dispersion of the precondensate and of the binder is advantageous. The aqueous solution or dispersion of the precondensate and of the binder should be liquid enough to allow it to be easily spread out on the substrate, but not so liquid that it rapidly penetrates or is soaked into the deeper layers of the substrate upon spreading.

Furthermore, it is advantageous to achieve a good and as uniform as possible distribution of the aqueous solution or dispersion of the precondensate and of the binder on the corresponding resin application devices, for example pressure rollers, doctor blade or sieve, in order to ensure an even transfer of the aqueous solution or dispersion of the precondensate and of the binder on the substrate, for example, paper, paperboard, cardboard, woven fabrics (including so-called tissues), knitted fabrics and nonwoven fabrics (including so-called nonwovens).

Furthermore, it is advantageous to establish a suitable viscosity of the aqueous solution or dispersion of the precondensate and of the binder so that, upon application of the aqueous solution or dispersion of the precondensate using the spray method, the drop size of the precondensate is as small as possible, the drops do not block the spray nozzle and are spread evenly on the substrate.

The aqueous solution or dispersion of the precondensate and of the binder therefore comprises a polymeric thickener in the range from 0.01 to 10% by weight, preferably in the range from 0.01 to 5% by weight, based on the aqueous solution or dispersion of the precondensate and of the binder.

In order to prepare the products according to the invention, the solution or dispersion of the precondensate and of the binder (also referred to below as “preparation solution”) can be applied to the substrate either over the whole area or else in the form of a pattern. The viscosity of the preparation solution, i.e. of the aqueous solution or dispersion of the precondensate and of the binder with or without curing agent, is usually adjusted by adding the thickeners according to the invention and then applied to the substrate and only then cured.

The preparation solution according to the invention is preferably applied in the unfoamed state to the respectively considered substrate. For example, it can be applied to the flat substrate by spraying, knife coating, rolling, printing, inter alia with screen printing, or with the help of other suitable technical equipment known to the person skilled in the art, such as e.g. a sizing press, a film press, an airbrush, a unit for curtain coating. Preferably, contactless processes or processes with as low a pressure as possible on the flat substrate are employed in order to reduce the absorption of the resin into the substrate.

Application can be to one or both sides, either simultaneously or in succession. The amount of curable resin which is applied to the flat substrate with the help of the preparation solution is for example 0.1 to 90% by weight, preferably 0.25 to 75% by weight, in particular 0.5 to 50% by weight, based on the areal weight of the uncoated dry flat substrate.

It is thus essentially less than the amount which is used for producing decorative films by impregnating flat substrates with melamine/formaldehyde resins. The amount of precondensate applied in each case to the substrate has a decisive influence on the flexibility, softness and the feel of the products according to the invention.

Moreover, the distribution of the preparation solution and of the cured resin on the substrate has a considerable influence on the flexibility of the products according to the invention. The preparation solution can for example be applied to the substrate unevenly, in which case, for example, it completely covers the substrate, but is not spread evenly thereon. A further variation consists in printing the preparation solution onto the flat substrate in a pattern. This gives for example particularly flexible products if the preparation solution is printed onto the substrate in the form of parallel stripes or as spots.

After applying the preparation solution to the flat substrate, the crosslinking of the heat-curable resin and of the binder and the drying of the flat substrates provided with a coating of a precondensate of a heat-curable resin and of the the binder are carried out, it being possible for crosslinking and drying to run simultaneously or in succession. One advantageous embodiment consists in crosslinking the heat-curable resin and the binder in a moist atmosphere and then drying the product. The thermal curing of the resins and the drying of the products can take place for example in the temperature range from 20 to 250° C., preferably 20 to 200° C., particularly preferably 20 to 150° C.

The drying step can be performed for example also in gas driers or in IR driers. The higher the temperature employed in each case, the shorter the residence time of the material to be dried in the drying equipment. If desired, the product according to the invention can also be tempered at temperatures up to 300° C. after drying. Temperatures above 300° C. can also be used for curing the resin, although the required residence times are then very short.

Sizes and impregnating resins which are each sold as aqueous binders or powders based on condensates of urea, melamine and formaldehyde as Kauramin® and Kaurit® from BASF SE, are used in the furniture and construction industry for producing plate-like wood products such as chipboard, sheets of plywood and covering boards, cf. technical information on Kaurit®. Papers impregnated with impregnating resins have a hard surface. Such products can be found, for example, in surfaces of laminate floorings, or in the decoration of furniture, cf. technical information on Kauramin®.

Flexible, flat substrates are obtained which are used as cloths for the cleaning of surfaces in the home and in industry. They are particularly suitable as abrasive wipes for the surface cleaning of objects made of metal, glass, porcelain, plastic and wood. The products according to the invention are especially suitable as disposable articles but may optionally be used several times. Multiple use is provided especially for those products according to the invention which comprise a fabric or nonwoven fabric as substrate.

Upon wiping surfaces made of glass, metal or plastic, the substrates according to the invention develop a scouring effect which is desired for cleaning these surfaces. In this connection, however, the scouring effect is much less than that of emery paper, meaning that the substrates according to the invention are suitable for all applications in which only a slight scouring effect is desired for removing dirt, meaning that the surface of the materials wiped with the substrates according to the invention is practically not damaged or scratched. The products according to the invention are preferably used as disposable articles but may also be used several times, depending on the particular application.

The percentages in the examples are percentages by weight, unless the context suggests otherwise.

### EXAMPLES

Preparation of the Coated Papers

Comparative Preparation Solution A

A precondensate of melamine and formaldehyde (Kauramin® KMT 773, BASF SE) was used to prepare a 30% strength aqueous solution by mixing 175 ml of completely demineralized water with 75 g of impregnating resin powder and 1.5 g of guar flour. 1.5 g of ammonium nitrate (50% strength) and 100 μl of a fluorine-substituted surface-active agent (Zonyl® FS 300, DuPont) were added to 30 g of this solution and the mixture was carefully mixed to give a homogeneous solution.

Preparation Solution 1

A precondensate of melamine and formaldehyde (Kauramin® KMT 773, BASF SE) was used to prepare a 30% strength aqueous solution by mixing 175 ml of completely demineralized water with 75 g of impregnating resin powder and 1.5 g of guar flour. 30 g of an aqueous acrylate dispersion (Acrodur® 32 D, BASF SE) and 1.5 g of ammonium nitrate (50% strength) were added to 30 g of this solution and the mixture was mixed carefully to give a homogeneous solution.

Preparation Solution 2

A precondensate of melamine and formaldehyde (Kauramin® KMT 773, BASF SE) was used to prepare a 30% strength aqueous solution by mixing 175 ml of completely demineralized water with 75 g of impregnating resin powder and 1.5 g of guar flour. 30 g of an aqueous polyurethane dispersion (Emuldur® 360A, BASF SE) and 1.5 g of ammonium nitrate (50% strength) were added to 30 g of this solution and the mixture was carefully mixed to give a homogeneous solution.

Preparation Solution 3

A melamine-formaldehyde precondensate (Kaurit® impregnation system 820 from BASF SE) was used to prepare a ca. 50% strength aqueous solution by mixing 91 g of completely demineralized water with 109 g of impregnation system solution and 1,7 g of guar flour. 2.2 g of ammonium nitrate (50% strength) were added to 45 g of this solution and the mixture was carefully mixed to give a homogeneous solution.

### Comparative Example A (Screen Printing, Comparative Preparation Solution A)

Some of comparative preparation solution A was applied to one side of a piece of kitchen roll (TORK® (premium) kitchen roll, SCA) measuring 23.8 cm×25.7 cm and having a weight per area of 53 g/m² using a screen printing press and triple coating. The coated material was then placed on a plate made of aluminum and dried in a drying cabinet for 20 min at 120° C. The paper was then dry and crosslinked. The amount of resin that has been applied was, after drying, 11 g/m², based on dry kitchen roll.

### Example 1 (Screen Printing, Preparation Solution 1)

Some of preparation solution 1 was applied to one side of a piece of kitchen roll (TORK® (premium) kitchen roll, SCA) measuring 23.8 cm×25.7 cm and with a weight per area of 53 g/m² using a screen printing press and triple coating. The coated material was then placed on a plate made of aluminum and dried in a drying cabinet for 15 min at 80° C. The paper was then dry and crosslinked. The amount of resin which has been applied was, after drying, 11 g/m², based on dry kitchen roll.

### Example 2 (Screen Printing, Preparation Solution 2)

Some of preparation solution 2 was applied to one side of a piece of kitchen roll (TORK® (premium) kitchen roll, SCA) measuring 23.8 cm×25.7 cm and having a weight per area of 53 g/m² using a screen printing press and triple coating. The coated material was then placed on a plate made of aluminum and dried in a drying cabinet for 15 min at 80° C. The paper was then dry and crosslinked. The amount of resin which has been applied was, after drying, 11 g/m², based on dry kitchen roll.

### Example 3 (Screen Printing, Preparation Solution 3)

Some of preparation solution 3 was applied to one side of a piece of kitchen roll (TORK® (premium) kitchen roll, SCA) measuring 23.8 cm×25.7 cm and with a weight per area of 53 g/m² using a screen printing press and triple coating. The coated material was then placed on a plate made of aluminum and dried in a drying cabinet for 15 min at 80° C. The paper was then dry and crosslinked. The amount of resin which has been applied was, after drying, 11 g/m², based on dry kitchen roll.

Assessing the Brittleness

The coated papers obtained according to the examples were tested as to their brittleness at the coated sites and compared both with the prior art and also with uncoated samples. For this purpose, when producing the coated papers according to the examples, a square pattern was chosen and this pattern was printed. This was alternating printed and nonprinted squares with an edge length of 7 mm. After curing and drying, the brittleness of the examples was assessed by reference to the printed squares. For this purpose, a plurality of printed squares were creased successively using the thumb and index finger of the right hand, the brittleness was felt and it was observed whether a cracking sound can be heard. The impression of brittleness obtained therein determines the relative brittleness (6=extremely brittle, clear cracking sound; 1=flexible, no cracking heard, cf. unprinted substrate; school grading system).

Cleaning Effect

The coated papers obtained according to the examples were tested as to their suitability as wiping cloths and compared with standard commercial uncoated papers. For this, the sample to be tested was in each case fixed to one side of a square punch with a side length of 21 mm and a weight of 460 g with the help of an adhesive. A glass plate was attached to a shaking machine (Crockmeter). Several marks were then drawn onto the glass plate using a permanent marker (Permanent Marker Edding 3000). The square punch was placed on this area, with the side of the punch stuck with the sample to be tested positioned in each case on the glass plate. The area of the plate to be cleaned was wetted with 0.5 ml of completely demineralized water. The shaking machine was working at 20 up-and-down strokes/min with a horizontal deflection of the plate of 5 cm. Eight strokes (4 up-and-down strokes) were carried out in the wet and the degree of removal of the markings on the plate was determined. For this, the relative cleaning effect (6=no effect, 1=completely removed, school grading system) was determined compared with reference samples.

Scratch Effect

Since scratching of the surfaces to be cleaned is undesired, the coated papers obtained according to the examples were tested as to their property of scratching surfaces and compared with standard commercial uncoated papers. For this purpose, the sample to be tested was fixed with the help of an adhesive to one side in each case of a square stamp having a side length of 21 mm and a weight of 460 g. A Plexiglas® plate was attached to a shaking machine (Crock-Meter). The shaking machine worked at 20 up-and-down strokes/min with a horizontal deflection of the plate of 5 cm. 20 strokes (10 up-and-down strokes) were carried out under dry conditions. The relative scratching effect was determined here compared to reference samples (6=heavily scratching, 1=no scratches visible, school grading system).

The tests carried out and the results obtained are given in the table below.

| | Relative | Relative | Scratch effect on |
|---|---|---|---|
| Cloth | brittleness | cleaning effect | Plexiglas ® |
| Comparative example A | 6 | 1 | 6 |
| Example 1 | 4 | 1 | 4 |
| Example 2 | 3 | 1 | 2 |
| Example 3 | 2 | 2 | 1 |
| Without coating | 1 | 6 | 1 |

1.-18. (canceled)

19. A flexible substrate with a flexible, abrasive surface, the flexible substrate comprising 0.1 to 90% by weight of a mixture, based on the uncoated flexible substrate, the mixture comprising:
99.985 to 20% by weight of a condensation product of at least one precondensate of a heat-curable resin;
0.005 to 10% by weight of a polymeric thickener selected from the group consisting of a biopolymer, an associative thickener, acompletely synthetic thickener, or any one mixture thereof;
0.01 to 10% by weight of a curing agent;
0 to 10% by weight of surface-active substances, surfactants or any one mixture thereof;
0 to 15% by weight of active ingredients and effect substances; and
0 to 75% by weight of water,
wherein the mixture comprises 10 to 70% by weight of one or more binders selected from the group consisting of polyacrylates, polymethacrylates, polyacrylonitriles, polyurethanes, and copolymers of acrylic acid esters and acrylonitrile, styrene and acrylonitrile, acrylic acid esters and styrene and acrylonitrile, acrylonitrile and butadiene and styrene, and any one mixture thereof.

20. The flexible substrate according to claim 19, wherein the substrate is selected from the group consisting of papers, paperboards, cardboards, woven fabrics, tissues, knitted fabrics, and nonwoven fabrics.

21. The flexible substrate according to claim 19, wherein the substrate is selected from the group consisting of papers, paperboards, woven fabrics, tissues, knitted fabrics and nonwoven fabrics.

22. The flexible substrate according claim 19, wherein the substrate is selected from the group consisting of paper, paperboard, cardboard packagings, cardboard made of cellulose fibers, woven fabrics, tissues, knitted fabrics and nonwoven fabrics, textile fibers or mixtures of textile fibers.

23. The flexible substrate according to claim 19, wherein the one or more binders is an aqueous binder selected from the group consisting of polyacrylates, polymethacrylates, polyacrylonitriles, polyurethanes, copolymers of acrylic acid esters and acrylonitrile, styrene and acrylonitrile, acrylic acid esters and styrene and acrylonitrile, acrylonitrile and butadiene and styrene, and any one mixture thereof.

24. The flexible substrate according to claim 19, wherein the precondensates are selected from the group consisting of melamine/formaldehyde precondensates, methanol etherified melamine/formaldehyde precondensates, urea/formaldehyde precondensates, melamine/urea/formaldehyde precondensates, melamine/urea/phenol/formaldehyde precondensates, urea/glyoxal precondensates and phenol/formaldehyde precondensates.

25. The flexible substrate according to claim 19, wherein the at least one precondensate is of melamine and formaldehyde in which the molar ratio of formaldehyde to melamine is 1:1 to 4:1.

26. The flexible substrate according to claim 19, wherein a solution or dispersion of the precondensate comprises 0.1 to 10% by weight of the curing agent selected from the group of acids or salts thereof, and an aqueous solutions of these salts.

27. The flexible substrate according to claim 19, wherein a solution or dispersion of the precondensate comprises 0.001 to 15% by weight of the surfactant, the surface-active substance or the mixture thereof.

28. The flexible substrate according to claim 19, wherein a solution or dispersion of the precondensate comprises 0.01 to 5% by weight of the biopolymer, associative thickener, completely synthetic thickener or the mixture thereof.

29. The flexible substrate according to claim 19, wherein a solution or dispersion of the precondensate is applied to an entire surface of the substrate.

30. The flexible substrate according to claim 19, wherein an aqueous solution or dispersion of the precondensate is applied as a pattern to a surface of the substrate.

31. The flexible substrate according to claim 19, wherein the amount of mixture which comprises the condensation product of at least one precondensate, the polymeric thickener, the curing agent and the binder, accounts for 25 to 75% by weight, based on the weight of an uncoated dry substrate.

32. The flexible substrate according to claim 19, wherein the active ingredients and effect substances, or any one mixture thereof is present from 0.001 to 15% by weight.

33. The flexible substrate according to claim 19, wherein the active ingredients and effect substances are present in an encapsulated form.

34. The flexible substrate according to claim 19 in the form of an abrasive cloth for the cleaning of surfaces in the home or an commercial setting.

35. A process for producing a flexible substrate with an abrasive surface according to claim 19, the process comprising:
applying an aqueous solution or dispersion of the mixture of at least one precondensate of a heat-curable resin to a top and/or bottom surface of a flexible substrate in an amount in the range from 0.1 to 90% by weight, based on the weight of an uncoated, dry substrate;
crosslinking the applied precondensate; and drying the treated foam,
wherein the aqueous solution or dispersion comprises;
99.985 to 20% by weight of the at least one precondensate of a heat-curable resin,
0 to 10% by weight of the polymeric thickener selected from the group consisting of a biopolymer, an associative thickener, a completely synthetic thickener, and any one mixture thereof,
0.01 to 10% by weight of the curing agent,
0 to 10% by weight of the bsurface-active substances, surfactants or mixtures thereof,
0 to 15% by weight of the dyes, pigments, or mixture thereof, and
0 to 75% by weight of the water, and
10 to 70% by weight of the one or more binders, based on the above mixture, selected from the group consisting of polyacrylates, polymethacrylates, polyacrylonitriles, polyurethanes, melamine-formaldehyde resins, phenol-formaldehyde resins, urea-formaldehyde resins, melamine-urea-formaldehyde resins, melamine-urea-phenol-formaldehyde resins, urea-glyoxal resins, and any one copolymer of acrylic acid esters and acrylonitrile, styrene and acrylonitrile, acrylic acid esters and styrene and acrylonitrile, acrylonitrile and butadiene and styrene.

36. The flexible substrate according to claim 19, wherein the applied mixture is cured and dried at a temperature in the range from 20 to 250° C.
